(19) United States
(12) Patent Application Publication
(10) Pub. No.: US 2010/0032030 A1
(43) Pub. Date: Feb. 11, 2010

(54) CONDENSER CLEANING AND PURIFICATION SYSTEM WITH COOLING TOWER PURIFICATION FOR OPEN LOOP CONDENSER AND CLOSED LOOP EVAPORATIVE CONDENSER COOLING TOWERS

(75) Inventor: Robert Raymond Peterson, South Lyon, MI (US)

Correspondence Address: HARNESS, DICKEY & PIERCE, P.L.C., P.O. BOX 828, BLOOMFIELD HILLS, MI, 48303, US

(73) Assignee: EH2O, LLC, South Lyon, MI (US)

(21) Appl. No.: 12/469,764

(22) Filed: May 21, 2009

Related U.S. Application Data
(60) Provisional application No. 61/128,515, filed on May 22, 2008.

(51) Int. Cl. F15D 1/00

(52) U.S. Cl. 137/561 R

(57) ABSTRACT

A water treatment system for use in open loop and closed loop evaporative condenser cooling towers operable to reduce scale and biofilm deposits within the condenser.

### CROSS-REFERENCE TO RELATED APPLICATIONS

This application claims the benefit of U.S. Provisional Application No. 61/128,515 filed on May 22, 2009. The entire disclosure of the above application is incorporated herein by reference.

### BACKGROUND OF THE INVENTION

With water treatment as it is today, both open loop cooling towers and closed loop cooling towers have water treatment that is injected into the cooling towers and dispersed by process pumps. These pumps do not operate on a continuous basis. When these pumps are not in operation, water treatment is not applied to the most critical components which typically includes the condenser. When the condenser does not have water treatment, it can accumulate with mineral deposits known as scaling or microbiological deposits known as biofouling. Scale and biofouling deposits severely reduces the thermal transfer characteristics of the condensers, thereby requiring them to operate at longer service intervals. This added run time is less efficient and requires additional electrical energy to run the condensers. It is known in the industry that pulse powered water treatment can clean existing scale and remediate biofilm. This invention provides an advantage over conventional cooling tower water treatment systems by keeping the condensers free from scale deposits and biofilm.

### SUMMARY OF THE INVENTION

This invention provides a cleaning and purification method that is operable while the condenser pumps are not in operation.

This invention also improves the function of Direct pulse powered water treatment with the addition of carbon dioxide.

This invention provides a method to use discharge purified water for a secondary purpose such as drip irrigation.

This invention improves the function of ultraviolet (UV) purification for cooling towers with discharge at the UV purifier unit, a linear actuator at the UV manual wiper, and filtering before the UV for keeping the quartz sleeve clean.

The invention eliminates stagnant conditions in cooling tower systems allowing a continuous water treatment.

The invention also improves non-chemical water treatment by enhancing pulse powered water treatment and UV water treatment for open and closed loop cooling towers.

This invention provides a method for keeping condensers clean and provide purified water throughout an open or closed loop cooling tower.

The invention eliminates stagnant conditions in cooling tower systems allowing a continuous water treatment.

The invention also improves non-chemical water treatment by enhancing pulse powered water treatment and UV water treatment for open and closed loop cooling towers.

This invention allows filtered and UV purified water to be used for secondary use.

### BRIEF DESCRIPTION OF THE DRAWINGS

FIG. 1 shows a water treatment system 10 in accordance with the present invention;

FIG. 2 shows an HVAC open loop condenser cleaning and purification recirculation loop;

FIG. 3 illustrates a closed loop evaporative condenser cooling tower with spraying system and connections for water treatment system of FIG. 2, which is a view of the components necessary for condenser cleaning and purification;

FIG. 4 illustrates a view of an open loop cooling tower with water basin and port for purifying water, with top deck water line for tower sweepers; and

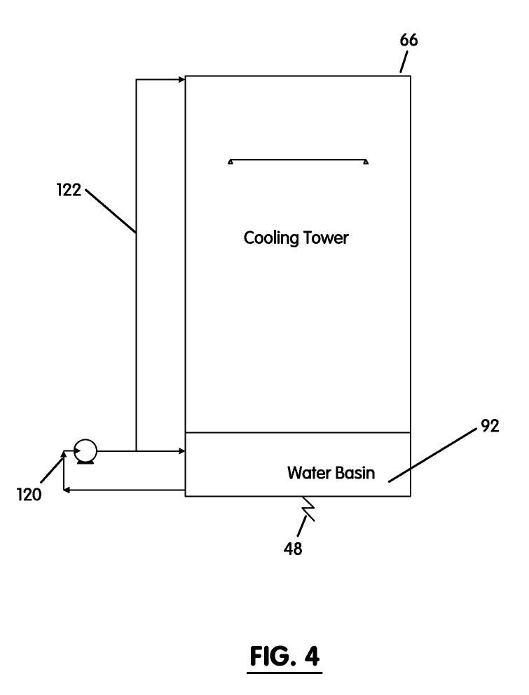

FIG. 5 shows the port configurations for discharging purified water for secondary use.

### DRAWINGS

### Reference Numerals

10—Water treatment system
12—Direct pulse powered mineral precipitator
13—Automatic conductivity controller
14—Ultraviolet water purifier (UV)
16—Water filter
18—Recirculation pump—suction against flow.
20—Intake line from cooling tower basin
22—Outlet to condenser recirculation
24—Electrically operated discharge valve
26—Open loop cooling tower water treatment system inlet
28—Open loop cooling tower water treatment system outlet
30—Contact switch on open loop condenser pump
32—Flow Switch
34—Check valve
36—Filter for condenser cleaner
38—Condenser cleaner recirculation pump
40—Electrically operated valve for water treatment
42—Inlet from water treatment rack
44—Timer actuated drain valve
46—Condenser recirculation dead leg drain line
48—Cooling tower basin recirculation pump suction line
50—Evaporative condenser water treatment inlet
52—Evaporative condenser water treatment outlet
54—Electrically actuated valve for evaporative condenser
56—Electrically actuated valve for closed loop cooling tower basin
58—Contact switch on closed loop evaporative condenser pump
60—Flow switch on evaporative condenser spray line
62—Spray manifold
64—Evaporative condenser closed loop cooling tower
66—Open loop cooling tower
68—Condenser
70—Condenser cleaner recirculation loop
72—Condenser open loop process pump(s)
74—Evaporative condenser closed loop condenser pump
76—Inlet in closed loop tower basin
78—Outlet in closed loop tower basin
80—Outlet from water treatment rack off condenser rack
82—Inlet to water treatment rack off condenser pump
84—Condenser cleaner system
86—Closed loop cooling tower condenser tubes
88—Closed loop cooling tower condenser tube sprayers
90—Closed loop cooling tower water basin
92—Open loop cooling tower water basin
94—Water treatment system line
96—Schedule 80 PVC tee for UV treated discharge
98—UV inlet or outlet threaded nipple
100—Ultraviolet purifier showing inlet or outlet
102—Linear actuator for UV wiper
104—Automatic timer unit
106—Carbon dioxide feeder
108—Recirculation pump for closed loop cooling tower water treatment
110—Schedule 80 PVC tee for UV discharge
112—Flow restrictor for UV treated water discharge
114—Shut off valve
116—Contact switch on recirculation pump
118—Dead leg
120 Cooling tower basin sweeper system
122 Saturation line for use with tower sweeper
124 Closed loop cooling tower pump spray line
126 Closed loop cooling tower pump suction line

### DETAILED DESCRIPTION OF THE PREFERRED EMBODIMENTS

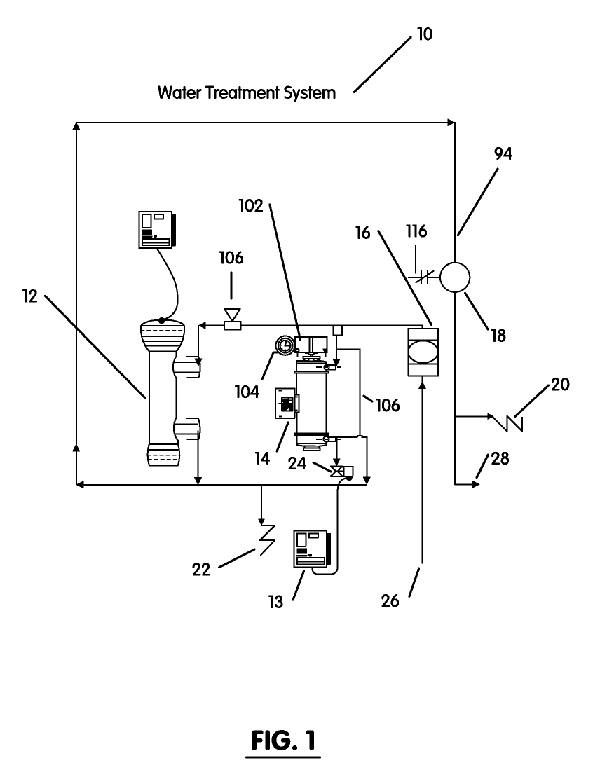

A water treatment system 10 is comprised of a water inlet 26 feeding a filter 16, an ultraviolet water purifier (UV) 14, and a direct pulse powered mineral precipitator 12. The water flows through piping 94 and components described above and is discharged to an outlet 28 located on a pump suction line 80. A suction against flow recirculation pump 18, pumping in the opposite flow as shown on FIG. 1, has a contact switch 116 and is controlled by a contact relay 30 on a condenser open loop process pump(s) 72 or controlled by a flow switch 32. A tee 20 is connected to a tee 48 to be used with the recirculation pump 18. The water discharge that is regulated by an automatic conductivity controller 13 is shown right after the UV purifier 14 operated by an electrically operated discharge valve 24. To improve the water treatment, a linear actuator for UV wiper 102 is located to replace the manual wiper handle of the UV purifier 14 with an automatic timer 104 to operate the linear actuator as desired. This automatic timer unit 104 is set to actuate the linear actuator 102 to stroke the quartz sleeve of the UV purifier for different desired times and intervals. As seen, a carbon dioxide feeder 106 is located before the Direct pulse powered mineral precipitator 12. This feeder 106 can also be located after the water filter 16 and before the UV purifier unit 14.

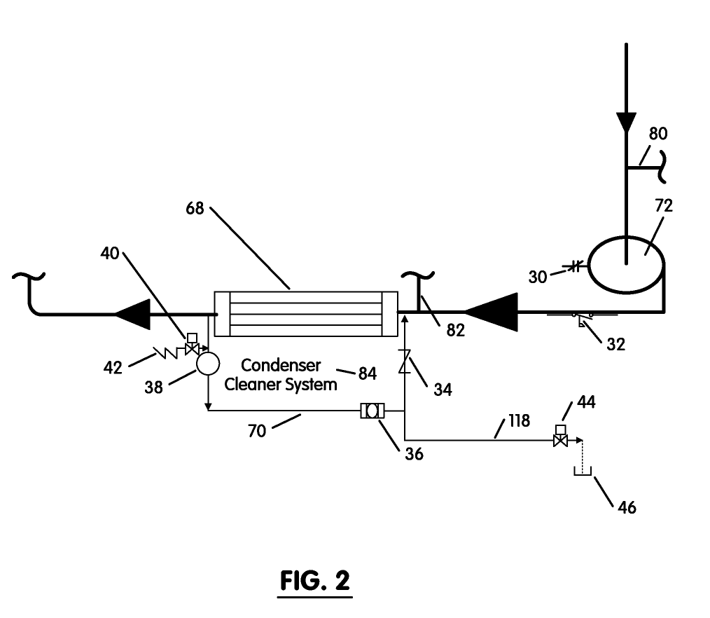

A condenser cleaner system 84 is incorporated around the condenser 68, as a condenser cleaner recirculation loop 70, as shown in FIG. 2. This condenser cleaner recirculation loop 70 has a filter 36 or a dead leg 118 with a timer actuated drain valve 44 to a drain 46. A condenser cleaner recirculation pump 38 can have a contact relay directing it to the pump contact switch on open loop condenser pump 30 attached to the condenser open loop process pumps 72 or by a flow switch 32 to operate the condenser cleaner recirculation pump 38 while the condenser open loop process pump(s) 72 are off. This feature deactivates the condenser cleaner recirculation pump 38 when the condenser open loop process pump(s) 72 are on. This recirculation loop is not limited to turning on and off with contact switches or a flow switch as described above and has the option to run on a continuous basis. This invention as described above is not limited to be connected to a contact switch on open loop condenser pump 30 if a contact switch is closer to the condenser cleaner recirculation pump 38 and the electrically operated valve for water treatment 40 is located at a power panel that is closer the condenser cleaner system 84.

An electrically operated valve for water treatment 40 with a water line 42 is connected to outlet to condenser recirculation 22 to feed treated water to the condenser cleaning loop. The electrically actuated valve 40 is controlled by the contact switch on open loop condenser pump 30, or flow switch 32. The inlet to water treatment rack 26 supplying water from condenser pump 82 can also feed treated water to the condenser recirculation loop 70 as shown in FIG. 2, if the water treatment system 10 can be located near the condenser 68. This invention is not limited to the use of electrically actuated valves and contact switches, whereas if the water treatment system 10 in FIG. 1 is installed near the condenser recirculation loop 70, the recirculation pump suction against flow 18 will circulate treated water into the condenser recirculation loop 70 via a close proximity inlet to water treatment rack off condenser pump 82. A check valve 34 is incorporated so the flow of the condenser open loop process pump(s) 72 cannot bypass or flow around the condenser 68.

This invention is also not limited to having a water treatment rack as a shown in FIG. 1, whereas the water treatment Pulse powered mineral precipitator 12, and UV water purifier 14 can be incorporated together or individually without Ultraviolet water purifier 14 directly to the recirculation loop 70 with recirculation pump 38 and filter 36. Since condensers operate in a lead and lag operation with flow eliminated on the lag condenser, this novel approach allows condenser cleaning for the lag condenser. Condenser cleaner filter 36 can be omitted whereas the recirculation with Direct pulse powered mineral precipitator 12 can keep the condenser deposit free. The recirculation pump 38 and Direct pulse powered mineral precipitator 12 are activated by a flow switch or the condenser operating sequence of the condenser equipment. This cleaning system is not limited to being permanently attached to a condenser as described above, and can also be incorporated manually without flow switches or communication to the condenser equipment, and moved or applied to each condenser that does not have flow. Since boilers have similar tubes for heating, and are lead and lag operation, this same technology can be used for cleaning boiler tubes and this technology is not just limited to condenser cleaning.

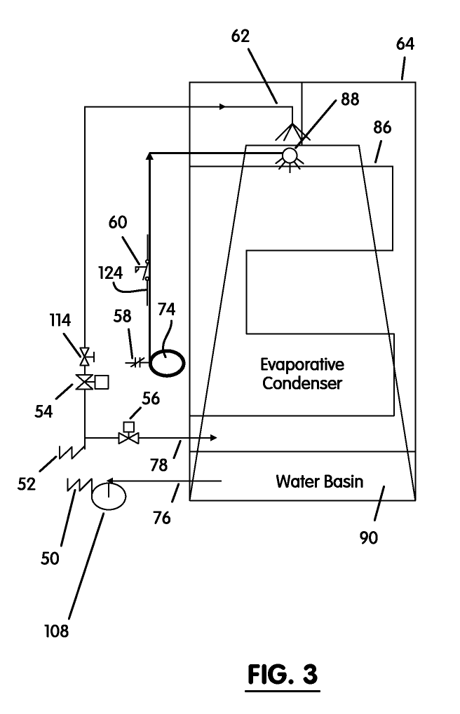

The closed loop cooling tower 64 shown in FIG. 3 is for evaporative condensers 86 that use an evaporative condenser closed loop condenser pump 74 and closed loop cooling tower condenser tube sprayers 88 on the condensing tubes. The water treatment inlet 50 supplies water to the water treatment system 10 that is piped with an inlet for a closed loop tower basin 76 under the water as shown in the closed loop cooling tower water basin 90. The flow direction of the water is shown with the arrows in FIG. 1. A separate pump 108 is used and the water flows into the outlet 52 through two electrically actuated valves 54 and 56 to the outlet in closed loop tower basin 78 and the spray manifold 62 above the closed loop cooling tower condensing tubes 86. This spray manifold 62 will have the necessary spray nozzles to saturate the top of the closed loop cooling tower condensing tubes 86. This invention is not limited to a separate spray manifold 62 and the water treatment as described above can be plumbed into the existing closed loop cooling tower condenser tube sprayers 88 to eliminate the separate spray manifold 62. The electrically actuated valves 54 and 56 are activated by a contact switch on closed loop evaporative condenser pump 58, or a flow switch 60. When the evaporative condenser closed loop condenser pump 74 is operating, the electrically actuated valve for evaporative condenser 54 is closed and the electrically actuated valve for closed loop cooling tower basin 56 is open. A non-electrically actuated shut off valve 114 can be installed in replacement of the electrically actuated valve for evaporative condenser 54 and the electrically actuated valve for closed loop cooling tower basin 56 can be eliminated. This allows a continuous saturation of the closed loop cooling tower condenser tubes 86.

The user can also install the water treatment system 10 on the closed loop cooling tower pump spray line 124 as an entire system as shown or just the Direct pulse powered mineral precipitator 12 for scale control to be used with the existing evaporative condenser closed loop condenser pump 74. Alternatively, the existing evaporative condenser closed loop condenser pump 74 can be replaced with a variable drive or variable speed pump so the electrically actuated valves 54 and 56 and contact switch 58 and flow switch 60 can be eliminated. The water treatment described above for installation in the cooling tower pump spray line 124 can also be incorporated on the closed loop cooling tower pump suction line 126. The closed loop cooling tower pump suction line 126 and the cooling tower pump spray line 124 can be shared as a side stream if desired. The stagnant water in the cooling tower 66 is recirculated with the inlet 48 in the water basin 92 plumbed to an intake line from cooling tower basin 20. When a cooling tower basin sweeper system 120 is used, a small port is incorporated after the tower basin sweeper pump. Attached to the port is a small line that runs to the top hot deck of the cooling tower. This small line is a saturation line for use with tower sweeper 122 and this supplies water to the top hot deck to keep the deck and fill saturated with a small stream of water for keeping the deck and fill clean.

The UV has ports that are used as the inlet or outlet 100 and a bushing 98 is incorporated inside a threaded tee 96 that has another tee 110 below that with a flow restrictor 112 underneath that tee. The water is discharged via a normal automatic conductivity controller 13 to the electrically operated discharge valve 24.

The Direct pulse powered mineral precipitator 12 operates at low amperage and watts. The ultraviolet water purifier 14 and the automatic conductivity controller 13 operate at low amperage and watts as well. This invention shall have the option to operate these components using a photovoltaic panel and battery with a power converter to operate these components.

For use with either open loop cooling towers that have a separate condenser or a closed loop cooling tower that has the condenser in the cooling tower, the water treatment system 10 is used to clean condensers and purify water in the system on a continuous basis. This allows the condenser tubes 68 and 86 to be cleaned when the main pump(s) 72 and 108 are off.

The main purpose is a condenser cleaning and purification system but the user has the option to draw stagnant water from the cooling tower basin recirculation pump suction line 48 to the intake line from cooling tower basin 20 to remedy stagnant conditions. The water treatment components in FIG. 1 are used with a recirculation loop for condenser cleaning and water purification as shown in FIG. 2 and FIG. 3. This invention provides many options for the user with this cleaning and purification method. The condenser cleaner recirculation loop 70 has a separate condenser cleaner recirculation pump 38 that circulates water through a filter for condenser cleaner 36 for the condenser cleaner system 84 but can also incorporate a dead leg 118 with a timer actuated drain valve 44 that goes after the dead leg drain line. A dead leg 118 accumulates solids and can replace the condenser cleaner filter 36. A check valve 34 is installed on the condenser cleaner recirculation loop 70 that prevents flow from the condenser open loop process pump(s) 72.

This invention is not limited to this design and the user has the option to not purchase a water treatment rack 10 in FIG. 1 and install a Direct pulse powered mineral precipitator 12 with or without an ultraviolet water purifier 14 to the condenser recirculation loop 70. First the user can provide treated water if FIG. 1 is not near the condenser by implementing a electrically operated valve for water treatment 40 with an inlet from the water treatment rack 42 to the outlet to condenser recirculation 22. If FIG. 1 can be place near the condenser 68, the treated water is implemented next to the condenser as shown with inlet to water treatment rack off condenser pump 82, while the recirculation pump suction against flow 18 drives the treated water to inlet to water treatment rack off condenser pump 82 so the electrically operated valve for water treatment 40 and outlet to condenser recirculation 22 and inlet from water treatment rack 42 system with a contact or flow switch can be eliminated. In an open loop cooling tower, the recirculation pump 18 is activated when the condenser open loop process pump(s) 72 are deactivated.

In a closed loop cooling tower, the recirculation pump for closed loop cooling tower water treatment 108 is always operating and the evaporative condenser closed loop condenser pump 74 will open a electrically actuated valve for the evaporative condenser 54 when the condenser pump 74 is off, and activate an electrically actuated valve for the closed loop cooling basin 56 to close, allowing the condenser cleaning to take place. The activation process for the electrically operated valve for water treatment 40, the electrically actuated valve for evaporative condenser 54 and the electrically actuated valve for closed loop cooling tower basin 56 is activated by a contact switch on evaporative condenser pump 58 for closed loop cooling towers and a contact switch 30 located on the condenser open loop process pump(s) 72 for open loop cooling towers. The user has the option to not use contact switches on the pumps, but use a flow switch on evaporative condenser spray line 60 for closed loop cooling towers, or a flow switch 32 for open loop cooling towers, that closes the contact and allows the electrically actuated valves 40, 54 and 56 to operate as described above. The user also has the option with closed loop evaporative condenser cooling towers to not use the electrically actuated valves 54 and 56 or the contact switch on closed loop evaporative condenser pump 58, or flow switch on evaporative condenser spray line 60 and replace the electrically actuated valve for evaporative condenser 54 with a standard shut off valve 114. This allows the user to restrict flow to the spray manifold 62, which keeps the condensing tubes clean on a continuous basis. The spray manifold 62 consists of individual spray nozzles that provide a consistent spray pattern on the condenser tubes 86 when the cooling tower condenser tube sprayers 88 are not operating. FIG. 3 shows the spray manifold 62 above the closed loop cooling tower condenser tube sprayers 88 but the design is not limited to being above the cooling tower condenser tube sprayers 88. The height location of the spray manifold 62 is dictated by the desired flow pattern and the design of the Evaporative condenser closed loop cooling tower 64.

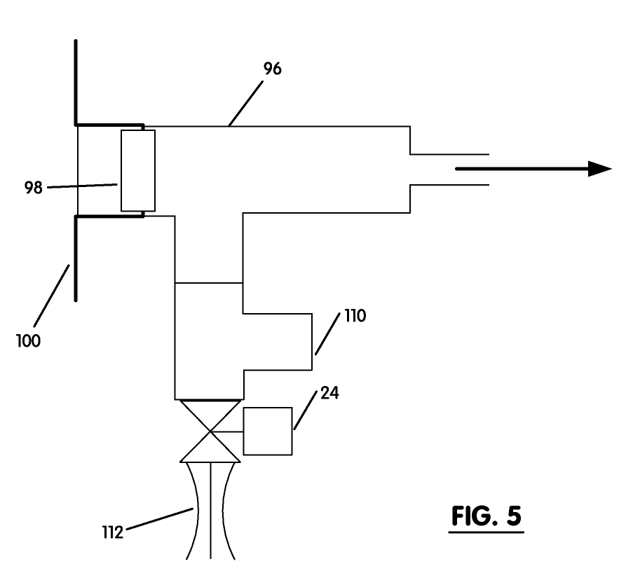

Improvements with non chemical water treatment are achieved by incorporating a carbon dioxide feeder 106 that can be located directly before the Direct pulse powered mineral precipitator 12 or after the filter 106. Since many water municipalities lime soften their water and do minor recarbonation, a second recarbonation will enhance the mineral precipitation process. FIG. 5 shows how the purified water can be used for a secondary use by immediately treating it with an ultraviolet purifier 14 and then discharging it. The discharge line consists of two tees that are each a schedule 80 PVC tee for UV treated discharge. FIG. 1 shows that the ultraviolet purifier 14 has a tee 96 located on each inlet and outlet. FIG. 5 shows only one of the ultraviolet purifiers 14 inlet or outlet. The tee 96 is located directly adjacent to each inlet and outlet of the ultraviolet water purifier 14 while the view is expanded as shown in FIG. 5. FIG. 5 shows the tee 96 that is threaded and provides a threaded nipple 98 to attach the tee 96 directly adjacent to the ultraviolet purifier 14. The Schedule 80 PVC tee for UV discharge 110 is designed to allow piping to the tee 96 on the other outlet and inlet as shown in FIG. 1. This allows purified water to be discharged either when the condenser open loop process pump(s) 72 is activated or the recirculation pump suction against flow 18 is activated; since the flow of each pump is opposite each other on open loop cooling tower systems. On closed loop evaporative cooling towers, only one tee 96 is needed.

On open loop cooling towers, below the tee 110 for open loop cooling towers is an electrically operated discharge valve 24 for discharging purified water. Below that valve is a flow restrictor for UV treated water discharge 112 that is set to the flow parameters for UV drinking water standards. On closed loop evaporative cooling towers, schedule 80 PVC tee for UV discharge 110 is eliminated and just one schedule 80 PVC tee for UV treated discharge 96 is required to the outlet of the ultraviolet purifier 14 with the discharge valve and flow restrictor as described above.

Purification is also accomplished by eliminating stagnant areas such as an open loop cooling tower water basin 92 by incorporating this water into the recirculation pump suction against flow 18 with a basin suction line 48.

Purification is enhanced by incorporating the linear actuator for UV wiper 102 onto the hand wiper of the ultraviolet water purifier (UV) 14 with an automatic timing unit 104 to power the actuator for the strokes needed on a daily basis. Having a water filter 16 before the UV also keeps the quartz sleeve that is surrounded by the ultraviolet lamp clean, improving the performance of UV sterilization with cooling towers. The ultraviolet water purifier 14 is modified with a sealant and or bell on both ends with sealant on the base that holds the ballast for weather proofing. Alternately, a pump can supply water from the water treatment system 10 to the top hot deck of the open loop cooling tower to provide a continuous water treatment for the cooling tower fill.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A water treatment system, comprising:
a water inlet feeding untreated water to a filter;
an ultraviolet water purifier downstream of said filter;
a direct pulse powered mineral precipitator downstream of said ultraviolet water purifier; and
a feeder unit for feeding carbon dioxide into the water between said filter and said direct pulse powered mineral precipitator.
